(19) United States
(12) Patent Application Publication
(10) Pub. No.: US 2017/0031096 A1
(43) Pub. Date: Feb. 2, 2017

(54) OPTICAL ELEMENT AND MANUFACTURING METHOD THEREFOR

(71) Applicant: NGK INSULATORS, LTD., Nagoya-City (JP)

(72) Inventors: Shoichiro YAMAGUCHI, Ichinomiya-City (JP); Keiichiro ASAI, Nagoya-City (JP); Jungo KONDO, Miyoshi-City (JP); Toshihiro TOMITA, Nagoya-City (JP)

(73) Assignee: NGK INSULATORS, LTD., Nagoya-City (JP)

(21) Appl. No.: 15/291,343

(22) Filed: Oct. 12, 2016

Related U.S. Application Data
(63) Continuation of application No. PCT/JP2015/062188, filed on Apr. 22, 2015.

(30) Foreign Application Priority Data
May 2, 2014 (JP) 2014-095138

(51) Int. Cl. G02B 6/124; G02B 6/13; B29D 7/01; G02B 5/18

(52) U.S. Cl. CPC G02B 6/124; G02B 5/1814; G02B 5/1852; G02B 6/13; B29D 7/01

(57) ABSTRACT

An optical element includes a support substrate and an optical material layer provided over the support substrate. A first fine pattern is formed on the surface of the support substrate. When forming the optical material layer, a second fine pattern, to which the first fine pattern P3 is transferred, is formed on the surface of the optical material layer.

### TECHNICAL FIELD

The present invention relates to optical elements, such as a grating element, and manufacturing methods therefor.

### BACKGROUND ART

The use of a nanoimprint method has been considered as a method for forming a diffraction grating included in a semiconductor laser element. The nanoimprint method is applied to the formation of the diffraction grating, which has an advantage because manufacturing costs of devices, such as a semiconductor laser, can be reduced, and the like.

In forming a diffraction grating by the nanoimprint method, first, a resin layer is formed on a semiconductor layer where the diffraction grating is to be created.

A mold having a concave—convex pattern corresponding to the shape of the diffraction grating is pressed onto the resin layer, and in this state, the resin layer is then hardened. In this way, the concave—convex pattern of the mold is imprinted into the resin layer. Thereafter, the shape of the resin layer is transferred to the semiconductor layer, thereby forming a fine structure in the semiconductor layer.

Patent Document 1 describes a method for manufacturing a distributed feedback semiconductor laser using the nanoimprint method. In this method, patterning of a semiconductor layer for forming a diffraction grating of the distributed feedback semiconductor laser is performed by the nanoimprint method.

Non-Patent Documents 1 and 2 describe fabrication of a sub-wavelength structured wide-band wavelength plate using the nanoimprint method.

Further, Non-Patent Document 3 describes how the nanoimprint technology is applied to fabricate optical devices. Such optical devices can include, for example, a wavelength selective element, a reflection control element, and a Moth-Eye structure.

[Patent Document 1] Japanese Patent Publication No. 2013-016650A

[Patent Document 2] Japanese Patent Publication No. 2009-111423A

[Non-Patent Document 1]

“Polymeric Wide-Band Wave Plate Produced via Nanoimprint Subwavelength Grating,” KONICA MINOLTA TECHNOLOGY REPORT, Vol. 2 (2005), Pages 97 to 100

[Non-Patent Document 2]

“Challenge for production of highly-functional optical elements at low costs-Realization of sub-wavelength periodic structure by glass imprint method” Synthesiology, Vol. 1, No. 1 (2008), pages 24 to 30

[Non-Patent Document 3]

Furuta, “Nanoimprint technology and its application to optical devices” monthly magazine “Display” June 2007, pages 54 to 61

### SUMMARY OF THE INVENTION

The inventors have tried to form an optical waveguide layer over a support substrate via a cladding layer with a concave-convex pattern having a pitch of several hundreds of nanometers (Bragg grating pattern) on the surface of the optical waveguide layer.

However, the optical waveguide is required to have a higher refractive index than the underlayer, and consequently is formed of a difficult-to-work material in many cases. When applying a grating process to the surface of the optical waveguide layer by the nanoimprint method, some optical waveguide layers are difficult to etch, depending on their materials, and thus are less likely to satisfy the optical properties of the grating. In particular, it is difficult to form a number of fine holes with some depth, leading to a failure of the patterning.

An object of the present invention is, in manufacturing an optical element including a support substrate, an optical material layer and a fine pattern formed in the optical material layer, to prevent a failure of a fine pattern formed in the optical material layer

The present invention provides an optical element including a support substrate and an optical material layer provided over the support substrate. A first fine pattern is formed on a surface of the support substrate, and a second fine pattern corresponding to the first fine pattern is formed on a surface of the optical material layer in forming the optical material layer.

The present invention further provides a method for manufacturing an optical element including a support substrate and an optical material layer provided over said support substrate. The method includes the steps of:
forming a first fine pattern on a surface of the support substrate; and
then forming the optical material layer so that a second fine pattern corresponding to the first fine pattern is formed on a surface of the optical material layer.

The inventors have studied about various means to solve the problem that an optical material layer experiences a failure of patterning or has a shallow concave portion in a pattern when imprinting the pattern of a mold into the optical material layer because of the less workability of the optical material layer in terms of etching. However, this problem has been proved to be difficult to solve.

Then, the inventors have changed their ideas and conceived of forming a fine pattern on the surface of a support substrate that is relatively easy to work with, and then transferring the fine pattern formed on the support substrate to an optical material layer when forming the optical material layer on the support substrate. The invention has been made by forming the fine pattern on the support substrate that is relatively easy to work with and transferring such a fine pattern to the optical material layer deposited on the substrate, thereby successfully suppressing the patterning failure.

### BRIEF DESCRIPTION OF DRAWINGS

FIG. 1(a) is a schematic diagram showing a support substrate 1, a resin layer 2 and a mold 3, FIG. 1(b) is a schematic diagram showing a state of transferring a designed pattern P1 of the mold to the resin layer 2, and FIG. 1(c) is a schematic diagram showing a state of forming a transfer pattern P2 on a resin layer 2A;

FIG. 2(a) shows a state of forming a mask 3 on the support substrate 1, and FIG. 2(b) schematically shows a state of forming a first fine pattern P3 on the support substrate 1;

FIG. 3(a) schematically shows a state of providing a cladding layer 6 on a support substrate 5, FIG. 3(b) schematically shows a state of forming an optical material layer 7 on the cladding layer 6;

FIG. 4(a) is a front view schematically showing an optical element 10, FIG. 4(b) is a plan view schematically showing the optical element 10;

FIG. 5 is a photograph showing an end surface of the optical element; and

FIG. 6 is a graph showing reflection characteristics of a grating element.

### MODES FOR CARRYING OUT THE INVENTION

The present invention will be described in more detail below, with reference to the accompanying drawings as appropriate.

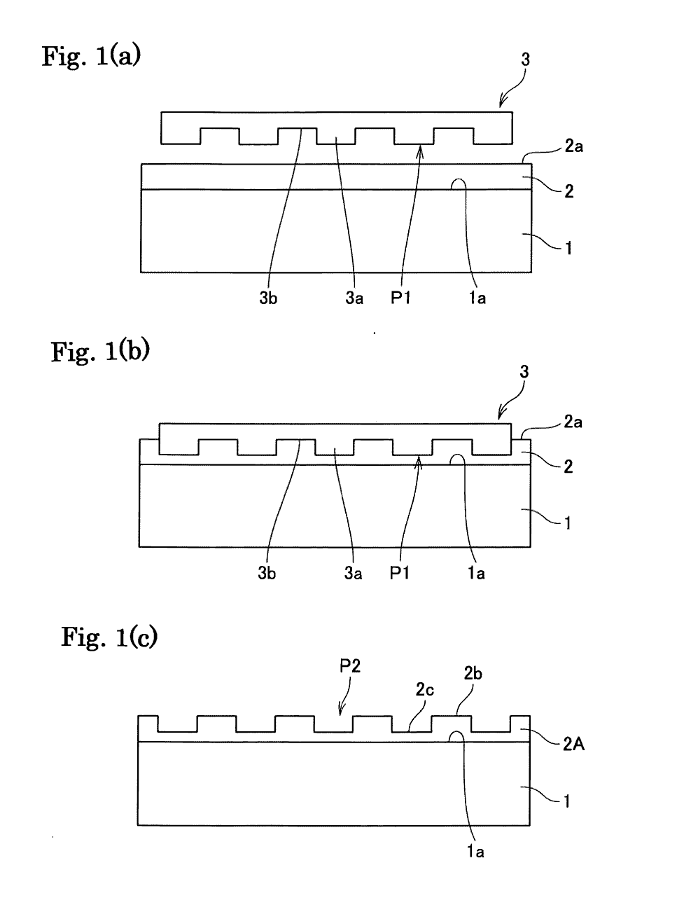

First, a designed pattern of a mold is transferred to a support substrate, preferably, by a nanoimprint method. For example, as shown in FIG. 1, a resin layer 2 is formed on a surface 1a of a support substrate 1, and a molding surface of a mold 3 is disposed facing a surface 2a of the resin layer 2. A designed pattern P1 is provided at the molding surface of the mold 3. In this embodiment, the designed pattern P1 includes concave portions 3b and convex portions 3b that are alternately arranged with a certain pitch therebetween.

When intended to transfer the designed pattern P1 of the mold 3, as exemplified in FIG. 1(b), the molding surface of the mold 3 is brought into contact with the resin layer 2, thereby transferring the designed pattern P1 to the resin layer. Then, as shown in FIG. 1(c), the mold is removed from the support substrate, whereby a transfer pattern P2 including convex portions 2b and concave portions 2c are formed in a resin layer 2A.

When imprinting on the resin layer 2 made of a thermoplastic resin, the resin layer 2 is softened by being heated up at a softening temperature of the resin or higher, and the mold is then pressed against the resin layer, allowing the resin to be deformed. After being cooled down, the resin layer 2A is cured. In contrast, when the resin layer 2 is made of a thermosetting resin, the mold is pressed against the uncured resin layer 2, causing the resin to be deformed. Subsequently, the resin layer is heated up at a polymerization temperature of the resin or higher, and thereby can be cured. Alternatively, when the resin layer 2 is formed of a photo curable resin, the mold is pressed against the uncured resin layer 2, thereby deforming the resin to transfer the designed pattern to the resin layer. Then, the resin layer 2 is irradiated with light and thereby can be cured.

After transferring the designed pattern to the resin layer, the support substrate is etched to form a fine pattern in the support substrate. At this time, the resin layer can serve as a mask. Alternatively, another mask material layer can also be provided between the resin layer and the support substrate.

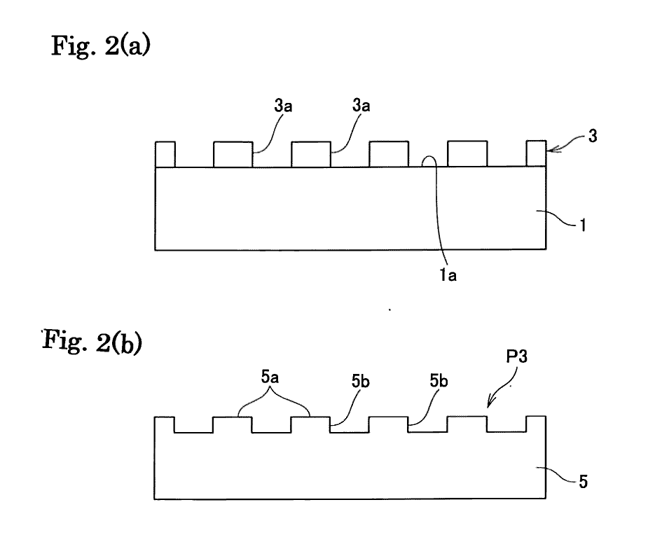

First, the use of the resin layer as the mask will be described. As illustrated in FIG. 1(c), resin remains on the bottom of each concave portion 2c of the resin layer 2A. The remaining resin is removed by ashing to produce a state shown in FIG. 2(a). Referring to FIG. 2(a), a number of through holes 3a are formed in a resin mask 3 with the surface 1a of the support substrate 1 exposed from the bottom of each through hole 3. Then, a part of the material of the support substrate is removed by etching using the resin mask 3 as a mask, thereby forming concave portions 5b. Parts located directly under the resin mask 3 are not etched and thereby are left as convex portions 5a (see FIG. 2(b)).

Subsequently, the resin mask 3 is removed, whereby the support substrate 5 is produced as shown in FIG. 2(b). The support substrate 5 is provided with a fine pattern P3 that includes the convex portions 5a and concave portion 5b formed periodically.

Now, the case of providing another mask material layer between the resin layer and the support substrate will be described. Also in this case, the designed pattern is transferred to the resin layer as mentioned above. Then, the resin remaining on the bottom of each concave portion in the resin layer is removed by ashing to expose the mask material layer as an underlayer. The mask material layer is to be exposed to the space via through holes formed in the resin layer.

Then, the mask material layer is etched to form a number of through holes in the mask material layer according to the designed pattern, thereby producing a mask. Then, the material of the support substrate located directly under the through holes of the mask is removed by etching to form the concave portions 5b as shown in FIG. 2(b). Parts of the support substrate directly under the mask remain as they are to thereby form the convex portions 5a. Subsequently, unnecessary resin layer and mask are removed, thus producing the support substrate 5 shown in FIG. 2(b).

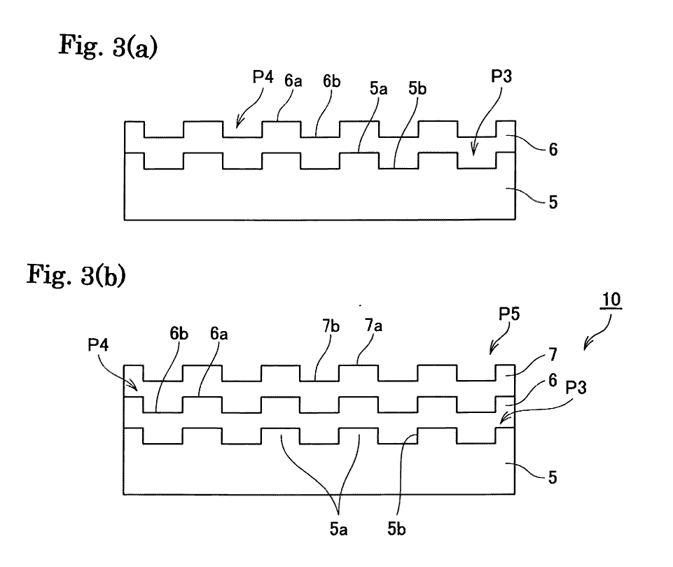

Then, as shown in FIG. 3(a), a cladding layer 6 is formed over the support substrate 5. The pattern of the convex portions 5a and concave portions 5b in the support substrate 5 is transferred to the cladding layer 6 during deposition, thereby forming a second fine pattern P4 including a repeated pattern of convex portions 6a and concave portions 6b.

Then, as shown in FIG. 3(b), an optical material layer 7 is formed over the cladding layer 6. The second fine pattern P4 including the convex portions 6a and concave portions 6b of the cladding layer 6 is transferred to the optical material layer 7 during the deposition, thereby forming a third fine pattern P5 including a repeated pattern of convex portions 7a and concave portions 7b. In this way, an optical element 10 is obtained.

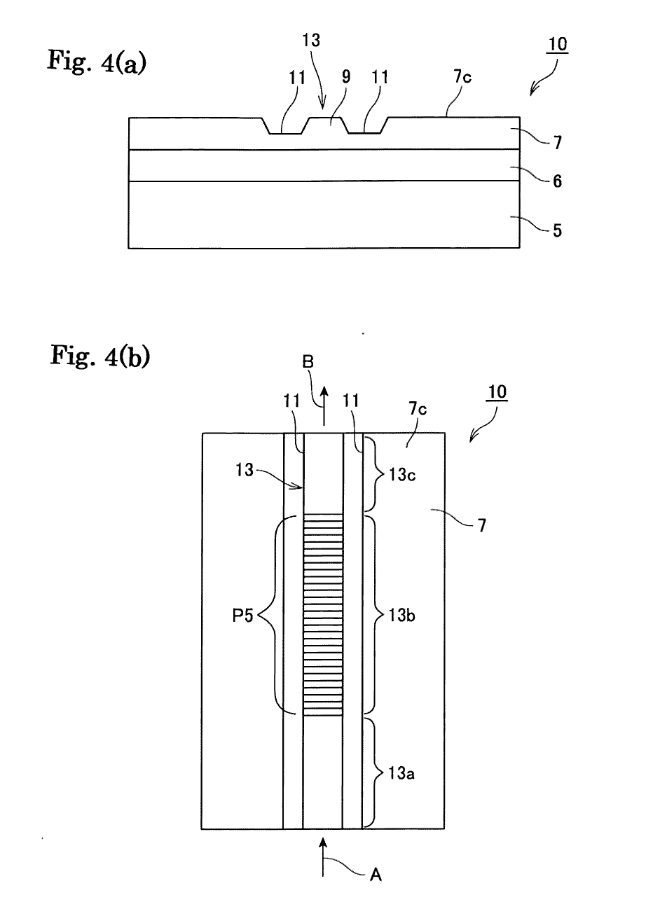

A preferred embodiment of the optical element is illustrated in FIG. 4. In the optical element 10 of this embodiment, for example, a pair of ridge grooves 11 is formed at a surface 7c side of the optical material layer 7, and a ridge portion 9 is formed between the pair of ridge grooves 11. The ridge portion 9 serves as a channel optical waveguide 13.

The planar shape of this channel optical waveguide is not particularly limited. However, as shown in FIG. 4(b), the pattern P5 of the Bragg grating is formed in the optical waveguide 13, thereby enabling the formation of a grating portion 13b. Preferably, an incident side propagation portion 13a and an emission side propagation portion 13c, which do not have a diffraction grating, can be further provided. The arrow A represents an incident light to the element, while the arrow B represents an emitted light.

However, the optical waveguide is not limited to the ridge optical waveguide, but may be a proton-exchanged optical waveguide, a titanium diffusion optical waveguide and the like. The optical waveguide may be a slab optical waveguide.

Specific materials for the support substrate are not particularly limited, but can include, for example, lithium niobate, lithium tantalate, AlN, SiC, ZnO, glass, such as silica glass, synthetic silica, quartz crystal, and Si. Here, preferable materials for the support substrate are glass, such as silica glass, synthetic silica, quartz crystal, and Si in terms of the easiness of processing the support substrate.

The thickness of the support substrate is preferably 250 μm or more in terms of handling, and preferably 1 mm or less in terms of downsizing.

The optical material layer is preferably formed of optical material, such as silicon oxide, zinc oxide, tantalum oxide, lithium niobate, lithium tantalate, titanium oxide, aluminum oxide, niobium pentoxide, and magnesium oxide. A refractive index of the optical material layer is preferably 1.7 or more, and further preferably 2 or more.

To further improve the optical damage resistance of the optical waveguide, the optical material layer may contain one or more kinds of metal elements selected from the group consisting of magnesium (Mg), zinc (Zn), scandium (Sc), and indium (In). In this case, magnesium is particularly preferable. Crystals of the optical material layer can contain a rare-earth element as a doping agent. Suitable rare-earth elements include, particularly preferably, Nd, Er, Tm, Ho, Dy, and Pr.

The thickness of the optical material layer is not particularly limited. In terms of reducing the propagation loss of light, the thickness of the optical material layer is preferably in a range of 0.5 to 3 μm.

When providing the cladding layer, the leak of propagation light into the support substrate can be suppressed by increasing the thickness of the cladding layer. From this point, the thickness of the cladding layer is preferably 0.5 μm or more.

Note that an upper cladding layer can be further provided on the surface of the optical material layer.

The cladding layer and the upper cladding layer are formed of a material that has a lower refractive index than the material for the optical material layer, and can be formed of silicon oxide, tantalum oxide, and zinc oxide. The refractive index of the cladding layer or upper cladding layer can be adjusted by doping therein. Such dopants can include P, B, Al, and Ga.

Materials for the mask material layer can include, for example, Cr, Ni, Ti, Al, tungsten silicide, and the multi-layer film thereof.

The optical material layer, cladding layer, and upper cladding layer may be a single layer, or alternatively a multi-layer film.

The optical material layer, cladding layer, and upper cladding layer may be deposited and formed over by a thin-film formation method. Suitable thin-film formation methods can include sputtering, vapor deposition, and CVD.

The fine pattern formed in the support substrate or the optical material layer means a pattern with a pitch of 10 μm or less. The pattern having a pitch of 1 μm or less is particularly effective. Specific components with such a fine pattern can include, for example, a sub-wavelength structure wide-band wavelength plate, a wavelength selective element, a reflection control element, a Moth-Eye structure, a Bragg grating, and a ridge optical waveguide.

Preferable etching methods are as follows.
Dry etching and wet etching can be exemplified.
The dry etching is, for example, a reactive etching or the like. Examples of suitable etching gas can include fluorine based gas and chlorine based gas.
In the wet etching, examples of suitable etchant can include a hydrofluoric-acid based etchant, and a tetramethylammonium hydroxide (TMAH) based etchant.

### Examples

A method according to the invention was performed to fabricate an optical element shown in FIG. 4 with reference to FIGS. 1 to 3.

Specifically, a Si substrate was used as the support substrate. The support substrate was dry-etched using SF₆ and O₂. To produce an optical element having the reflection characteristics showing the reflection at a wavelength of 980 nm, it was appropriate to set a pattern pitch of a concave-convex fine pattern at about 240 nm. For this reason, a mold with a concave-convex pattern pitch of about 240 nm was used. A resin layer, to which a designed pattern of the mold was transferred, was one made of an ultraviolet curable resin. The depth of the concave portion depends on the reflectivity, and thus was set at approximately 100 nm to stabilize an oscillation wavelength of a laser.

The cladding layer 6 was formed on the surface of the support substrate 5 with the first fine pattern P3 formed thereon. The cladding layer was formed in a thickness of 1 μm by sputtering using SiO₂ as a cladding material.

Then, the optical material layer 7 was formed of Ta₂O₅ on the cladding layer 6. The thickness of the optical material layer was set at 2 μm, and sputtering was used as the deposition method.

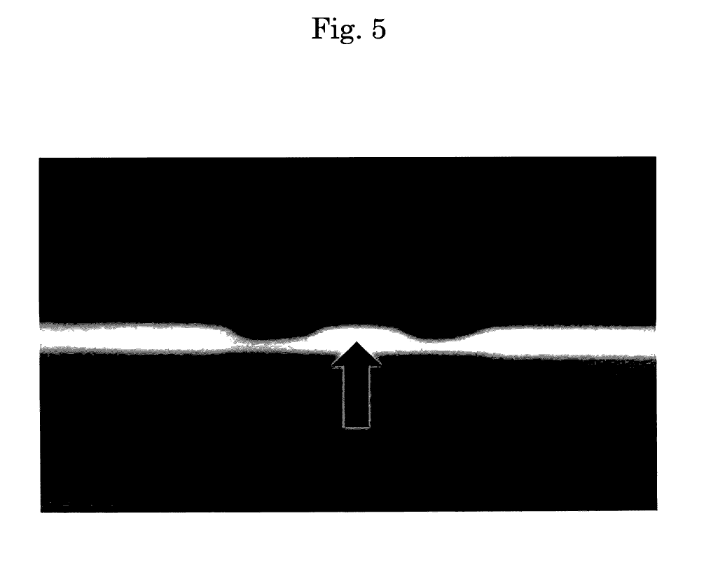

Subsequently, as shown in FIG. 4, a pair of ridge grooves were formed to thereby form a ridge portion. In this example, the width of the ridge portion was set at 3 μm, and the depth of the ridge groove was set at 1 μm. Thus, an optical element was obtained that trapped light at a wavelength of 980 nm in a ridge optical waveguide and allowed the light to propagate therein. FIG. 5 shows a photograph of the obtained optical element as viewed from the incident end surface side of the light.

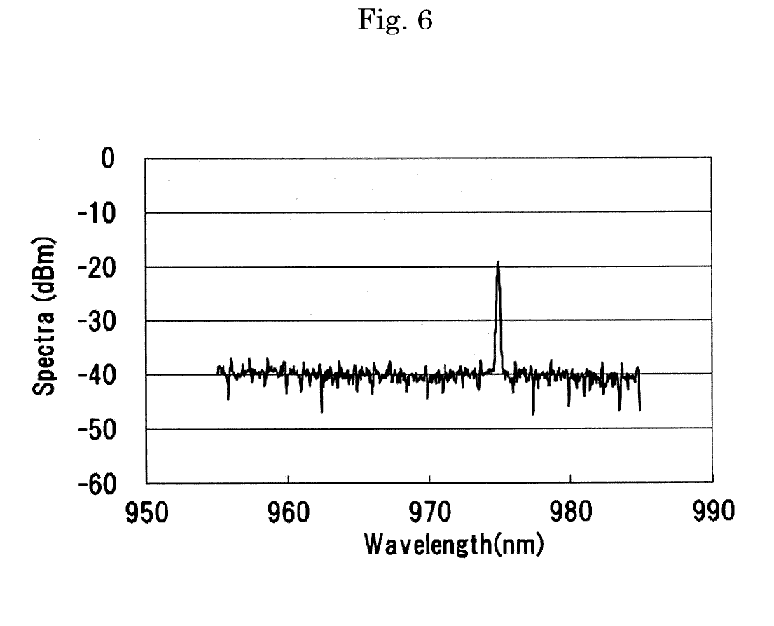

As shown in FIG. 4, the optical element had a grating pattern P5 formed with a length of 50 nm and including concave and convex portions arranged periodically (with a pitch of 240 nm). The reflection characteristics of the optical element are shown (see FIG. 6). As shown in FIG. 6, monophasic reflection characteristics, contributing to the grating, were able to be observed.

As an application example of the optical element in this example, a combination of the optical element and a semiconductor laser light source for the light, for example, with a wavelength of 980 nm was able to produce a light source having a stable oscillation wavelength of 975 nm. Further, a combination of the optical element and a wavelength conversion element phase-matched thereto at a wavelength of 975 nm was able to produce a blue-green light source for second harmonic generation (SHG) exhibiting stable output wavelength and output power.

1. An optical element comprising:
a support substrate; and
an optical material layer provided over said support substrate,
wherein a first fine pattern is formed on a surface of said support substrate; and
wherein a second fine pattern corresponding to said first fine pattern is formed on a surface of said optical material layer in forming said optical material layer.

2. The optical element of claim 1, further comprising a cladding layer formed between said support substrate and said optical material layer, wherein a third fine pattern corresponding to said first fine pattern is formed in said cladding layer.

3. The optical element of claim 1, wherein said first fine pattern in said support substrate is formed by an imprint method using a mold provided with a designed pattern corresponding to said first fine pattern.

4. The optical element of claim 1, wherein said second fine pattern comprises a sub-wavelength structure, a wide-band wavelength plate, a wavelength selective element, a reflection control element, a Moth-Eye structure or a Bragg grating.

5. A method for manufacturing an optical element, said optical element comprising a support substrate and an optical material layer provided over said support substrate, the method comprising the steps of:
forming a first fine pattern on a surface of said support substrate; and
then forming said optical material layer so that a second fine pattern corresponding to said first fine pattern is formed on a surface of said optical material layer.

6. The method of claim 5, further comprising the steps of:
forming a cladding layer over said support substrate so that a third fine pattern corresponding to said first fine pattern is formed in the cladding layer; and
then forming said optical material layer over said cladding layer.

7. The method of claim 5, wherein said first fine pattern is transferred to said support substrate by an imprint method using a mold provided with a designed pattern corresponding to said first fine pattern.

8. The method of claim 5, wherein said second fine pattern comprises a sub-wavelength structure, a wide-band wavelength plate, a wavelength selective element, a reflection control element, a Moth-Eye structure or a Bragg grating.
